(19) United States
(12) Patent Application Publication
(10) Pub. No.: US 2011/0186008 A1
(43) Pub. Date: Aug. 4, 2011

(54) ENGINE BRAKING DEVICE FOR AN INTERNAL COMBUSTION ENGINE

(75) Inventor: Martin Zapf, Turnau (AT)

(73) Assignee: AVL LIST GMBH

(21) Appl. No.: 12/998,083

(22) PCT Filed: Sep. 17, 2009
(86) PCT No.: PCT/EP2009/062041

§ 371 Date: Apr. 13, 2011

(30) Foreign Application Priority Data
Sep. 18, 2008 (AT) A 1457/2008

(51) Int. Cl. F02D 13/04

(52) U.S. Cl. 123/321

(57) ABSTRACT

The invention relates to an engine braking device (1) for an internal combustion engine comprising at least one outlet poppet valve (2) per cylinder, said valve actuatable through an outlet camshaft, wherein the engine braking device (1) acts on the outlet poppet valve (2) through a braking cam (4) of a braking camshaft (3) and through a valve lever (8) that is preferably designed as a rocker. In order to provide a low-friction engine braking device (1) in as simple a manner as possible, a piston (7) is disposed between the braking cam (4) and the valve lever (8), said piston being guided in a guide cylinder (6).

The invention relates to an engine braking device for an internal combustion engine comprising at least one outlet poppet valve per cylinder, said valve actuatable through an outlet camshaft, wherein the engine braking device acts on the outlet poppet valve through a braking cam of a braking camshaft and through a valve lever that is preferably designed as a rocker.

DE 101 16 143 A1 describes an engine brake in which the outlet valves are additionally opened in the compression cycle to achieve a braking power in the engine. This opening is achieved by a braking camshaft with a braking cam. Upon rotation of the braking camshaft, the braking cams thereof press onto a free end of a rocker mounted on the cylinder head. The opening of the outlet valves and consequently the braking power can be controlled by means of the angle of rotation of the braking camshaft. The normal outlet is accomplished by means of a conventional camshaft and the outlet cams disposed thereon. A disadvantage is that a linear contact is made between the braking cam and the valve lever upon actuation, which leads to appreciable wear.

Further known from AT 003.978 U1 is an internal combustion engine having an engine braking device with at least one engine braking valve designed as a poppet valve, which valve is disposed in addition to the gas exchange valves in the cylinder head and can be actuated via a braking valve lever against the force of a closing spring in engine braking mode. The actuation of the engine braking valve is accomplished by rotating or displacing a braking cam connected to the engine braking valve.

DE 28 32 542 A1 discloses an internal combustion engine having an engine brake which achieves the braking through opening one of the gas exchange valves by providing a hydraulic tappet in the valve drive, in which at least one piston is guided longitudinally movably between a lower and an upper stop. The piston is hydraulically activated for the braking and during normal operation of the engine is held in a resilient manner in a rest position by the force of a spring. Similar engine braking devices are disclosed in U.S. Pat. No. 4,796,573 A and EP 0 593 908 A1. A braking cam different from the outlet cam is not provided for activating the engine brake.

It is the object of the invention to provide an engine braking device having the lowest possible complexity and low wear.

According to the invention, this is achieved by providing a piston guided in a guide cylinder between the braking cam and the valve lever, wherein preferably a surface contact takes place between the braking cam and the piston at least in engine braking mode.

The braking cam has an elevation region having a first cam radius and a base region having a second cam radius, the second cam radius preferably being greater than the first cam radius. For example, the second cam radius can be twice as large as the first cam radius.

In order avoid linear contact between the cam and the piston, in a particularly preferred embodiment it is provided that the piston has a contact surface with the braking cam which is concavely curved, preferably cylindrical in sections. The contact surface can further have a central first concave region having a first radius of curvature which substantially corresponds to the first cam radius. It is particularly advantageous in this case if the contact surface has at least one second concave region adjoining the first concave region, having a second radius of curvature, wherein the second radius of curvature is greater than the first radius of curvature, and wherein preferably the second radius of curvature substantially corresponds to the second cam radius. In this way, it can be ensured that both when the engine braking device is activated and when it is deactivated, a linear contact between the cam and the piston is avoided.

In order to achieve minimal wear, furthermore the braking cam and/or the piston should be made of hardened case-hardened steel or of roller bearing steel.

In a very compact embodiment of the invention, it is provided that the braking cam and the guide cylinder are disposed in the bearing block of the rocker.

It is particularly advantageous if the valve lever acts on the outlet poppet valve via a valve coupling piece, wherein the valve coupling piece is mounted axially displaceably in a valve actuating part, preferably in a valve bridge. It is thereby prevented that a second outlet valve is possibly also opened by the valve actuating part when the engine braking device is activated.

The rotating of the camshaft can be accomplished by an electrical actuator, purely mechanically or mechanically-hydraulically.

In a particularly preferred embodiment of the invention it is provided that the braking cam is hydraulically adjustable, wherein preferably a hydraulically adjustable rack engages in a gear wheel firmly connected to the braking cam. Alternatively to this, the braking cam can also be adjusted by a control linkage via a lever.

The invention is explained in detail hereinafter with reference to the figures. In the figures:

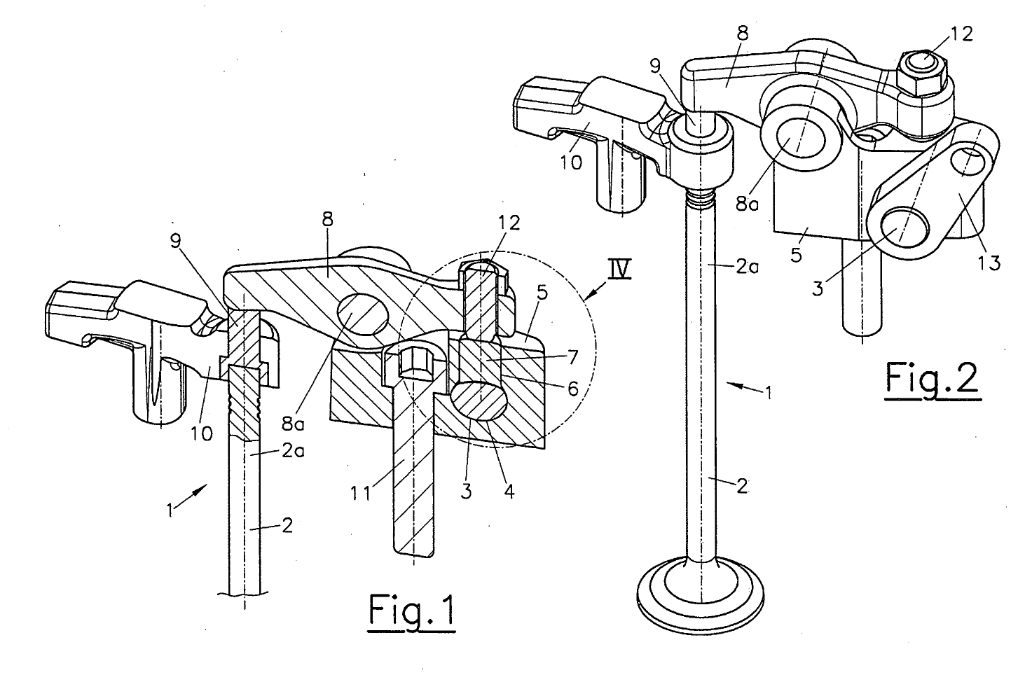

FIG. 1 shows an engine braking device for an internal combustion engine according to the invention in a sectional oblique view;

FIG. 2 shows an engine braking device in a first embodiment in an oblique view;

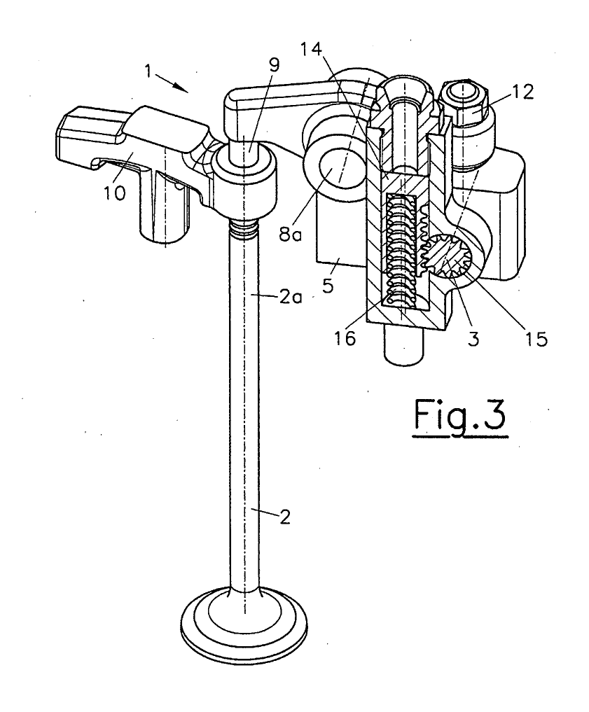

FIG. 3 shows the engine braking device in a second embodiment;

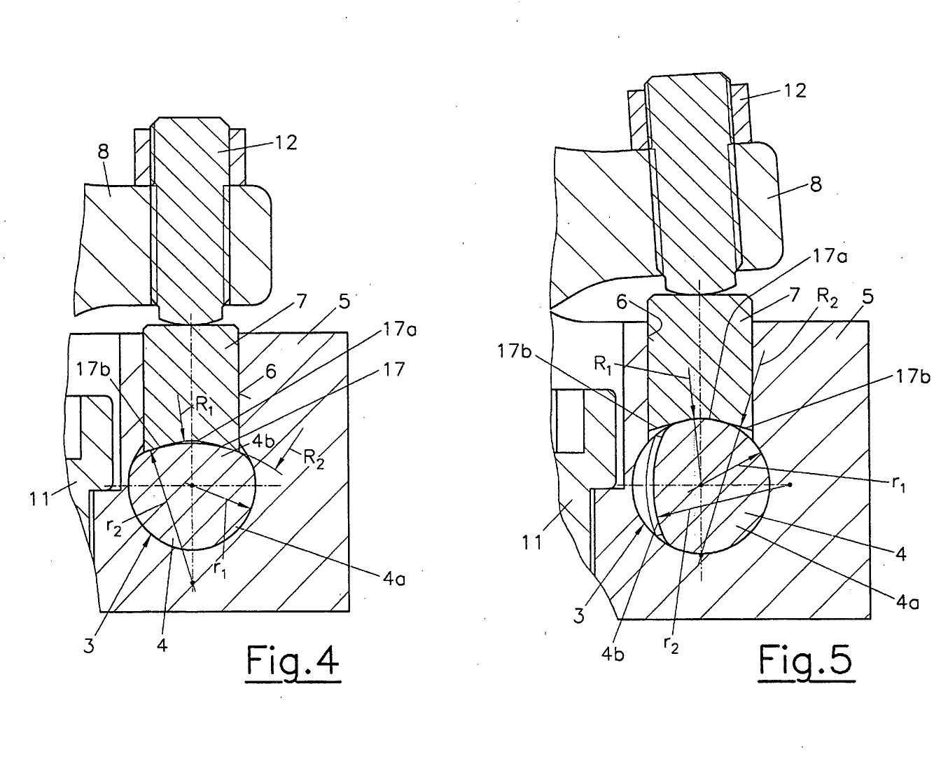

FIG. 4 shows the detail IV from FIG. 1 of the deactivated engine braking device; and

FIG. 5 shows this detail with the engine braking device activated.

FIGS. 1 to 3 each show an engine braking device 1 for an internal combustion engine, where the engine braking device 1 acts on an outlet poppet valve 2 which opens into a combustion chamber not shown further. The engine braking device 1 comprises a braking camshaft 3 having a braking cam 4 which is rotatably mounted in a bearing block 5. The braking cam 4 acts, via a piston 7 which is mounted displaceably in a guide cylinder 6 of the bearing block 5, on a lever 8 designed as a rocker, which lever acts on the stem 2a of the outlet poppet valve 2 via a valve decoupling piece 9. The valve decoupling piece 9 is mounted axially displaceably in a valve actuating part, for example, a valve bridge 10. Acting on the valve bridge 10, directly or indirectly, is an outlet camshaft, not shown further, for actuating two outlet poppet valves, of which only the outlet poppet valve 2 is shown. The axis of the valve lever 8 is designated by 8a. The bearing block 5 is fastened by means or one or a plurality of screws 11 to a cylinder head top deck not shown further.

An adjusting screw 12 is provided on the lever 8 for the fine adjustment of the engine braking device 1.

When the braking camshaft 3 rotates, the piston 7 moves by a predefined path of, for example, 2 mm in the direction of the valve lever 8 and enables it to tilt, whereby the outlet poppet valve 2 is opened. The rotation of the braking camshaft 3 can be accomplished by means of an actuating lever 13, as shown in FIG. 2, or by means of a rack 14 (see FIG. 3). The actuating lever 13 can be connected in a known manner via a control linkage to a pneumatic or hydraulic actuating device.

In the embodiment shown in FIG. 3, the braking camshaft 4 has a gear wheel 15 in which the rack 14 engages. The rack 14 which is configured as a pressure piston has pressure applied hydraulically in braking mode and rotates the camshaft by means of the gear wheel 15 through an angle of about 90° over the toothed structure. When disengaging the braking mode, the rack 14 is relieved hydraulically, with the result that this is pushed back into the starting position by means of the spring 16.

FIG. 4 shows a detail of the engine braking device in normal mode, that is with the engine braking device 1 deactivated, and FIG. 5 shows this detail in engine braking mode. It can be clearly deduced that both in the normal mode and in the engine braking mode, a wear-intensive linear contact between the braking cam 4 and the piston 7 is avoided. In this case, it is essential that the piston 7 has a concave contact surface 17 which nestles against the braking cam 4 particularly in the engine braking mode but advantageously also in the normal mode. The braking cam 4 in this case has an elevation region 4a having a first cam radius r₁ and a base region 4b having a second cam radius r₂. In the exemplary embodiment, the second cam radius r₂ is configured to be larger than the first cam radius r₁, the second cam radius r₂ being approximately twice as large as the first cam radius r₁.

The contact surface 17 of the piston 7 has a central concave first region 17a, the radius of curvature R₁ of the first region 17a substantially corresponding to the first cam radius r₁. The contact surface 17 further comprises two concave second regions 17b adjoining the first region 17a, the radius of curvature R₂ of each second region 17b substantially corresponding to the second cam radius r₂.

The contact partners cam 4 and piston 7 should be made at least of hardened case-hardened steel or roller bearing steel.

It is thereby ensured that both in the engine braking mode and in the normal mode, flat contact exists between the cam 4 and the piston 7. Wear can thus be reduced to a minimum.

1. An engine braking device for an internal combustion engine comprising at least one outlet poppet valve per cylinder, said valve actuatable through an outlet camshaft, wherein the engine braking device acts on the outlet poppet valve through a braking cam of a braking camshaft and through a valve lever, wherein a piston guided in a guide cylinder is disposed between the braking cam and the valve lever.

2. The engine braking device according to claim 1, wherein a surface contact takes place between the braking cam and the piston at least in engine braking mode.

3. The engine braking device according to claim 1, wherein the braking cam has an elevation region having a first cam radius.

4. The engine braking device according to claim 3, wherein the braking cam has a base region having a second cam radius.

5. The engine braking device according to claim 4, wherein the second cam radius is greater than the first cam radius.

6. The engine braking device according to claim 1, wherein the piston has a contact surface with the braking cam which is concavely curved.

7. The engine braking device according to claim 6, wherein the contact surface has a central first concave region having a first radius of curvature which substantially corresponds to the first cam radius.

8. The engine braking device according to claim 15, wherein the contact surface has at least one second concave region adjoining the first concave region, having a second radius of curvature, wherein the second radius of curvature is greater than the first radius of curvature.

9. The engine braking device according to claim 1, wherein the braking cam and/or the piston are made of hardened case-hardened steel or of roller bearing steel.

10. The engine braking device according to claim 1, wherein the braking cam and the guide cylinder are disposed in the bearing block of the valve lever.

11. The engine braking device according to claim 1, wherein the valve lever acts on the outlet poppet valve via a valve coupling piece, wherein the valve coupling piece is mounted axially displaceably in a valve actuating part.

12. The engine braking device according to claim 1, wherein the braking cam is electrically adjustable.

13. The engine braking device according to claim 1, wherein the braking cam is hydraulically adjustable.

14. The engine braking device according to claim 1, wherein the braking cam can be rotated by means of an actuating lever.

15. The engine braking device according to claim 5, wherein the second cam radius is twice as large as the first cam radius.

16. The engine braking device according to claim 6, wherein the braking cam is cylindrical in sections.

17. The engine braking device according to claim 8, wherein the second radius of curvature substantially corresponds to the second cam radius.

18. The engine braking device according to claim 11, wherein the valve coupling piece is mounted in a valve bridge.

19. The engine braking device according to claim 13, wherein a hydraulically adjustable rack engages in a gear wheel firmly connected to the braking cam.
